(19) United States
(12) Patent Application Publication
(10) Pub. No.: US 2019/0375091 A1
(43) Pub. Date: Dec. 12, 2019

(54) Multiple Screwdriver Bit Storing Screwdriver

(71) Applicant: Jiahao Dai, Chengdu (CN)

(72) Inventor: Jiahao Dai, Chengdu (CN)

(21) Appl. No.: 16/433,571

(22) Filed: Jun. 6, 2019

Related U.S. Application Data
(60) Provisional application No. 62/681,550, filed on Jun. 6, 2018.

(51) Int. Cl. B25G 1/08; B25B 15/02; B25B 23/00

(52) U.S. Cl. CPC B25G 1/085; B25B 15/007; B25B 23/0035; B25B 15/02

(57) ABSTRACT

The present invention generally relates to screwdrivers. Specifically, embodiments of the present invention are directed towards a screwdriver device having the ability to engage with an assortment of screwdriver bits on the uppermost portion of its shaft and the ability to conveniently store said assortment of screwdriver bits.

### CROSS-REFERENCE TO RELATED APPLICATION

This application claims the benefit of U.S. Provisional Application No. 62/681,550, filed Jun. 6, 2018, the entire disclosure of which is hereby incorporated by reference in its entirety.

### FIELD OF THE INVENTION

The present invention generally relates to screwdrivers. Specifically, embodiments of the present invention are directed towards a screwdriver device having the ability to engage with an assortment of screwdriver bits on the uppermost portion of its shaft and the ability to conveniently store said assortment of screwdriver bits.

### BACKGROUND OF THE INVENTION

Traditional screwdrivers have a one head profile, requiring consumers to purchase and store a selection of screwdrivers, each of which is only compatible with a single screw profile. Some advancements in the art include screwdriver devices having interchangeable screwdriver bits to facilitate engagement with a broad range of screws. However, the current state of the art lacks a screwdriver device having the ability to store a plurality of screwdriver bits on the body of the screwdriver itself, making the screwdriver bits accessible from the exterior portion of the screwdriver device, and thus easily accessible to users while the device is in use. Therefore, there is a need in the art for a screwdriver device that has the ability to accommodate and store a plurality of screwdriver bits on the exterior of the screwdriver, and allows users to store and easily and efficiently transfer between different screwdriver bits. These and other features and advantages of the present invention will be explained and will become obvious to one skilled in the art through the summary of the invention that follows.

### SUMMARY OF THE INVENTION

The present invention is directed to a screwdriver device that is configured to store a plurality of screwdriver bits and having an elongated shaft able to receive any one of said plurality of screwdriver bits.

It is an aspect of the present invention to provide an easily accessible means of storing screwdriver bits on the screwdriver device's exterior, making the screwdriver bits easily accessible to users, thereby making the replacement of the screwdriver bits more efficient.

The several embodiments of the present invention primarily comprise a screwdriver body having a handle, an elongated shaft, and an easily accessible storage means on its exterior, where the storage means is able to stow a plurality of screwdriver bits.

### BRIEF DESCRIPTION OF THE DRAWINGS

Accompanying this written specification is a collection of drawings of exemplary embodiments of the present invention. One of ordinary skill in the art would appreciate that these are merely exemplary embodiments, and additional and alternative embodiments may exist and still be within the spirit of the invention as described herein.

FIG. 1 shows a perspective view of a multiple screwdriver bit storing screwdriver, in accordance with an embodiment of the present invention.

FIG. 2 shows a front view of a multiple screwdriver bit storing screwdriver in accordance with an embodiment of the present invention.

FIG. 3 shows a top view of handle a multiple screwdriver bit storing screwdriver in accordance with an embodiment of the present invention.

FIG. 4 shows a bottom view of a multiple screwdriver bit storing screwdriver in accordance with an embodiment of the present invention

FIG. 5 shows an exploded view of a multiple screwdriver bit storing screwdriver, in accordance with an embodiment of the present invention.

FIG. 6 shows an exploded view of a handle and storage element of a multiple screwdriver bit storing screw driver, in accordance with an embodiment of the present invention.

### DETAILED SPECIFICATION

As shown in the figures, a screwdriver device embodied in the present invention is comprised of the component parts, which are hereinafter described.

The present invention generally relates to a combination screwdriver device having the ability to receive and store an assortment of screwdriver bits that may be configured with different screw head profiles, shapes, and configurations.

Embodiments of the present invention are generally directed to a screwdriver device comprising an elongated shaft, a handle, and a storage element comprising a plurality of storage members adapted to receive screw bits.

In an embodiment of the present invention, a handle is provided with a first end and a second end, with an elongated shaft extending from its second end. In some embodiments, a portion of the elongated shaft is threaded to engage with a corresponding threaded cylindrical channel that is formed in the handle. In some embodiments, the elongated shaft is configured to receive a storage element for storing screwdriver bits. In some embodiments, a screw bit socket is disposed at the second end of the elongated shaft to facilitate engagement with an assortment of screwdriver bits. In some embodiments, the screw bit socket is hexagon-shaped. In some embodiments, the screw bit socket is magnetic and is adapted to receive a screwdriver bit.

The present invention further discloses a plurality of screwdriver bits, each of which has an end capable of releasably fastening to the screw bit socket.

According to an embodiment of the present invention, a storage element comprises a plurality of storage members or slots. In a preferred embodiment, each of the storage slots on the storage element is configured to reversibly engage with one of said multiple screwdriver bits. By storing each of the screwdriver bits in a storage slot, each of the screwdriver bits are readily accessible on the exterior of the screwdriver, thereby easily enabling a user to attach and store or remove and use the desired screwdriver bits.

In embodiments of the present invention, the storage element, which can either be engaged with the handle, the elongated shaft or both, is comprised of storage members or slots which act as fittings for storing an assortment of screwdriver bits. In some embodiments, the storage slots are crescent shaped snap fittings that are configured to allow a user to snap the assortment of screwdriver bits into place, with each individual screwdriver bit being reversibly attachable into one of the snap fittings on the storage element. In some embodiments, the snap fittings are composed of a hard rubber or similar material, which allows a user to easily snap the screwdriver bits into place, or easily remove the screwdriver bits from said snap fittings when so desired. In some embodiments, the storage slots on the storage element are relatively flat and magnetized, allowing for the magnetic attachment of the screwdriver bits to the storage element, and further providing an efficient means of fastening or detaching of the screwdriver bits to and from the magnetized storage slots on the storage element.

According to an embodiment of the present invention, the storage element may include a rotation module enabling the rotational movement of the storage element about the axis of the shaft. In a preferred embodiment, the rotation module comprises a rotary bearing joint, such as a ball bearing, roller bearing, such as a needle roller bearing, or any similar mechanical rotary fit joint. In some embodiments, the rotation module includes compression insert springs and roller balls. The compression insert springs may extend from extruded holes disposed along an end of the storage element such that the roller balls are fitted into roller ball fittings disposed at an end of the handle.

In some embodiments, the rotary bearing joint includes a roller bearing or similar bearing to facilitate the rotation of the storage element. In some embodiments, the bearing in the rotary bearing joint is a needle roller bearing or the like mechanical rotary fit bearing. In some embodiments, the roller bearing includes an interior ring, an exterior ring and a plurality of needle rollers. In some embodiments, the inner ring is a race. In some embodiments, the inner ring is a shaft. In some embodiments, the exterior ring is a race. In some embodiments, the exterior ring is a housing. In some embodiments, the roller bearing includes a hollow insert shaft ring, where the elongated shaft is placed within the hollow portion of the insert shaft ring, so that the rotary bearing joint is rotatable along the axis of the elongated shaft, while the elongated shaft remains stationary.

According to an embodiment of the present invention, the handle of the screwdriver device may be formed with a screwdriver bit receiving point. In a preferred embodiment, the screwdriver bit receiving point is a hexagonal or similar shaped cavity or inlet formed in the handle of the screwdriver that is configured to receive a screwdriver bit. By inserting a screwdriver bit into the screwdriver bit receiving point, a user can then use the handle to exert a greater amount of leverage during tightening and loosening of screws.

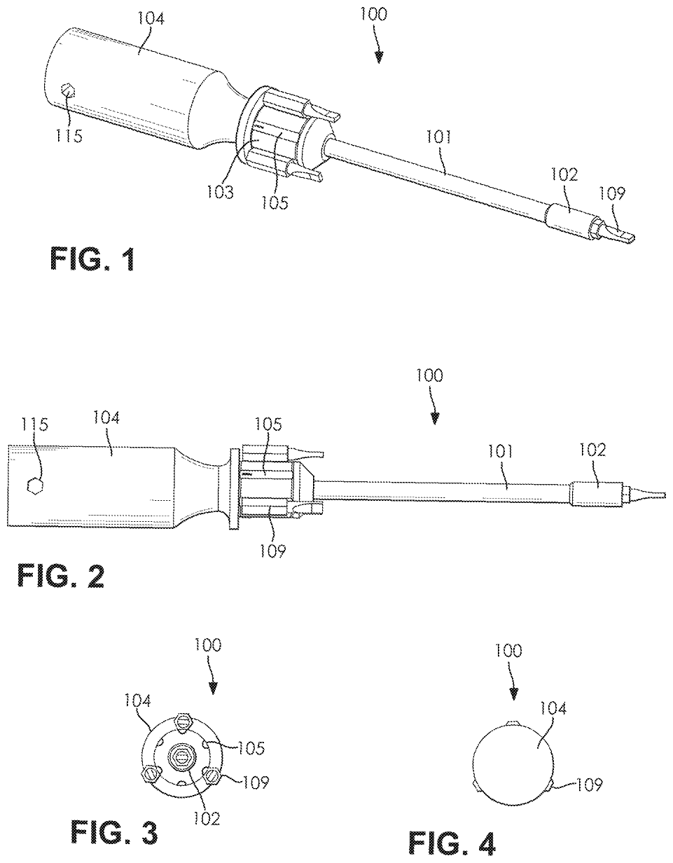

Turning to FIGS. 1-5, a screwdriver, in accordance with an embodiment of the present invention, is shown. In a preferred embodiment, the screwdriver device 100 primarily comprises an elongated shaft 101, a handle 104, and a storage element 103.

As shown in FIGS. 1-4, in accordance with embodiments of the present invention, the handle 104 is adapted to engage with the storage element 103. In some embodiments, the storage element 103 is comprised of a body having an opening or hole running through it. In some embodiments, the body is substantially tubular. In some embodiments, the storage element 103 includes a rotation module, making the storage element 103 rotatable about the central axis of the shaft 101. In some embodiments, the storage element 103 is rotatable about the central axis of the handle 104.

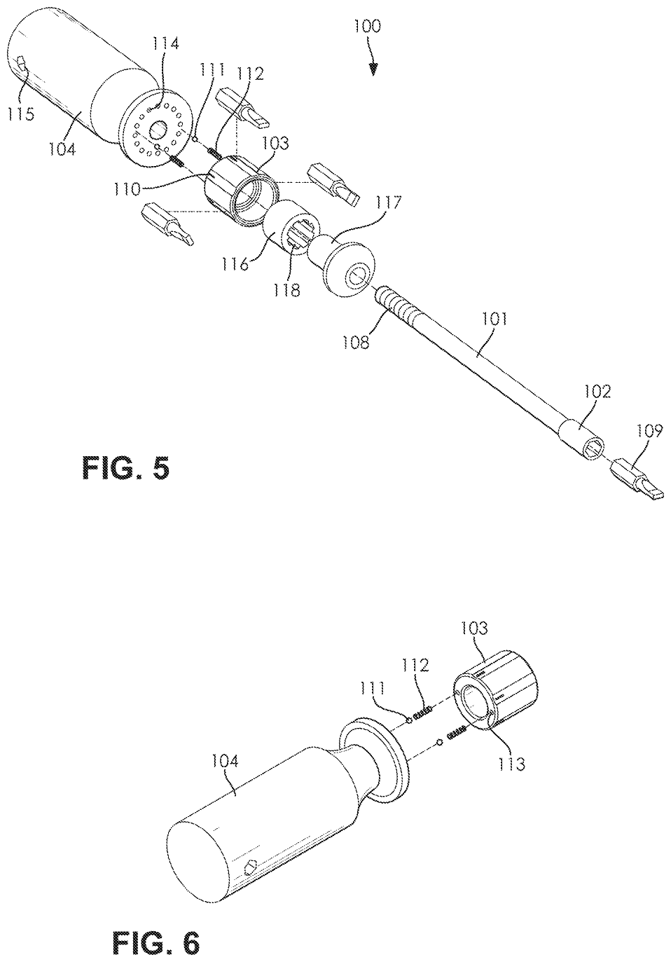

As shown in FIG. 5, in accordance with embodiments of the present invention, the storage element 103 includes a rotation module comprising a rotary bearing joint such as a needle roller bearing 116 to facilitate the rotational motion of the storage element 103. In some embodiments, the rotation module includes a hollow insert shaft ring 117, where the elongated shaft 101 is placed within the hollow portion of the insert shaft ring 117. The needle rollers 118 of the needle roller bearing 116 may roll along the exterior of the insert shaft ring 117, so that the needle roller bearing 116, engaged with the storage element 103, may be rotated along the axis of the elongated shaft 101, while the elongated shaft 101 remains stationary.

In accordance with embodiments of the present invention, the storage element 103 includes a plurality of storage members or slots 105 disposed along its exterior. In some embodiments, the storage slots 105 are snap fittings or magnetized fittings. In some embodiments, screw bits 109 friction fit into storage slots 105. In some embodiments, the storage members or slots 105 are crescent shaped snap fittings that are configured to allow a user to snap the assortment of screwdriver bits 109 into place, with each individual screwdriver bit 109 being reversibly attachable into one of the snap fittings on the storage element 103. In some embodiments, the snap fittings may be composed of a hard rubber or similar material, which allows a user to easily snap the screwdriver bits 109 into place, or easily remove the screwdriver bits 109 from said snap fittings when so desired. In some embodiments, the magnetized storage slots 105 are relatively flat and have magnets 110 disposed within them, allowing for engagement and storage of screwdriver bits 109.

In accordance with embodiments of the present invention, the rotation module includes a plurality of compression insert springs 112, holding roller balls 111 for rotatable engagement with the handle 104. The compression insert springs 112 may extend from extruded holes 113 located on the storage element 103 such that roller balls 111 may be fitted into roller ball fittings 114 located at an end of the handle 104.

In accordance with embodiments of the present invention, the handle 104 may be formed with a screwdriver bit receiving point 115. In a preferred embodiment, the screwdriver bit receiving point 115 is a hexagonal or similar shaped cavity or inlet formed in the handle 104 of the screwdriver device 100 that is configured to receive a screwdriver bit 109. By inserting a screwdriver bit into the screwdriver bit receiving point 115, a user can then use the handle 104 to exert a greater amount of leverage during tightening and loosening of screws.

In accordance with embodiments of the present invention, the elongated shaft 101 includes a threaded portion 108 at its first end and a screw bit socket 102 disposed at its second end. The screw bit socket 102 is adapted to receive a rear portion of a screw bit 109. In some embodiments, the shaft 101 threadably engages with the handle 104.

In accordance with an exemplary embodiment of the present invention, the screw bit socket 102 of the screwdriver device 100 may be used to accommodate screw bits 109 having differing head profiles, such that the screwdriver device 100 may be used to engage with a varying arrangement of screws having differing screw head profiles. Moreover, the device 100 may be used to conveniently store a plurality of the various screw bits 109 along the exterior of the screwdriver device 100. Having the screw bits 109 disposed along the exterior of the screwdriver device 100 provides users with easy access to the variety of screw bits 109, and allows users to easily select and withdraw a screw bit 109 from the storage element 103, and exchange it with a screw bit 109 disposed in the screw bit socket 102 atop the shaft 101.

In accordance with an exemplary embodiment of the present invention, the storage element 103 may be provided with a rotation module comprising a rotary bearing joint such as a needle roller bearing 116 having a plurality of needle rollers 118 located between the inner ring 119 and the exterior ring 120 of the needle roller bearing 116. In some embodiments, the rotation module further comprises a plurality of compression insert springs 112, and a plurality of roller balls 111. This configuration allows users to rotate the storage element 103 about the central axis of the shaft 101 or the handle 104. The needle rollers 118 are load-carrying components of the needle roller bearing 116 and are configured to reduce friction between moving components. The needle rollers 118 of the needle roller bearing 116 may roll along the exterior of the insert shaft ring 117, so that the needle roller bearing 116, engaged with the storage element 103, may be rotated along the axis of the elongated shaft 101, while the elongated shaft 101 remains stationary.

In accordance with an exemplary embodiment of the present invention, the compression insert springs 112 may be configured to hold the roller balls 111 in place and “lock” the storage element 103 in its place when the roller balls 111 are placed within the roller ball fittings 114 atop the handle 104. To rotate the storage element 103, a clockwise or counter-clockwise rotational force is applied to the storage element 103, compressing the compression insert springs 112 and retracting the roller balls 111 from within the roller ball fittings 114, thereby permitting the free rotational movement of the storage element 103 about the central axis of the shaft 101 or the handle 104 until the storage element 103 is rotated to the desired degree and the compression insert springs 112 and roller balls 111 are fitted into the roller ball fittings 114 on the handle 104. In this position, the compression insert springs 112 de-compress to allow the roller balls 111 to fit into the roller fittings, locking the storage element 103 in the same or different, and new, position.

The terminology used herein is for the purpose of describing particular embodiments only and is not intended to be limiting of the invention. As used herein, the term “and/or” includes any and all combinations of one of more of the associated listed items. It will further be understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A screwdriver assembly comprising:
a handle connected to a shaft having a screw bit socket at an end thereof, said handle further comprising a storage element having a body that is substantially tubular with an interior surface forming a chamber passing through the central axis of said storage element and adapted to receive at least a portion of said shaft and an exterior surface coupled to one or more screwdriver bit storage units.

2. The screwdriver assembly of claim 1, wherein said storage units are snap fittings for screw bits.

3. The screwdriver assembly of claim 1, wherein said storage units are relatively flush with said exterior surface of said storage element and include one or more magnets.

4. The screwdriver assembly of claim 1, wherein said storage element includes a rotation module.

5. The screwdriver assembly of claim 4, wherein said rotation module comprises a plurality of compression insert springs.

6. The screwdriver assembly of claim 5, wherein one or more roller balls are disposed within said compression insert springs.

7. The screwdriver assembly of claim 4, wherein said rotation module comprises a rotary bearing joint.

8. The screwdriver assembly of claim 7, wherein said rotary bearing joint is a needle roller bearing.

9. The screwdriver assembly of claim 1, wherein said handle further comprises a screwdriver bit receiving point.

10. A screwdriver assembly comprising:
a handle connected to a shaft having a screw bit socket at an end thereof, said handle further comprising a storage element having a rotation module and a body that is substantially tubular with an interior surface forming a chamber passing through the central axis of the storage element and adapted to receive at least a portion of said shaft and an exterior surface having one or more screwdriver bit storage units.

11. The screwdriver assembly of claim 10, wherein said storage units are snap fittings for screw bits.

12. The screwdriver assembly of claim 10, wherein said storage units are relatively flush with said exterior surface of said storage element and include one or more magnets.

13. The screwdriver assembly of claim 10, wherein said rotation module comprises a plurality of compression insert springs.

14. The screwdriver assembly of claim 13, wherein one or more roller balls are disposed within said compression insert springs.

15. The screwdriver assembly of claim 13, wherein said rotation module comprises a rotary bearing joint.

16. The screwdriver assembly of claim 15, wherein said rotary bearing joint is a needle roller bearing.

17. The screwdriver assembly of claim 10, wherein said handle further comprises a screwdriver bit receiving point.
